(19) United States
(12) Patent Application Publication
(10) Pub. No.: US 2012/0020114 A1
(43) Pub. Date: Jan. 26, 2012

(54) BACKLIGHT STRUCTURE

(75) Inventors: Hirofumi Miyamoto, Osaka-shi (JP); Tetsuya Hamada, Osaka-shi (JP)

(73) Assignee: SHARP KABUSHIKI KAISHA, Osaka-shi, Osaka (JP)

(21) Appl. No.: 13/257,404

(22) PCT Filed: Mar. 4, 2010
(86) PCT No.: PCT/JP2010/053512

§ 371 Date: Sep. 19, 2011

(30) Foreign Application Priority Data
Mar. 25, 2009 (JP) 2009-073138

(51) Int. Cl. F21V 8/00; F21V 29/00

(52) U.S. Cl. 362/612; 362/613

(57) ABSTRACT

A liquid crystal display apparatus (100) comprises light source modules (1) arranged at upper and lower edges, a light guide plate (2) arranged between the light source modules (1), a rear plate (3) arranged on the rear side of the light source modules (1) and the light guide plate (2), a fan mounting plate (4) arranged on the rear side of the rear plate (3), and a cooling fan (5) mounted on the fan mounting plate (4). The rear plate (3) is provided with protrusion portions (3a) which project toward the rear surface side of the light source modules (1). A cooling air passage (11) is formed between the fan mounting plate (4) and the rear plate (3). The fan mounting plate (4) is provided with L-shaped bent portions (4a) corresponding to the shape of the protrusion portions (3a) at the upper and lower end edges of the fan mounting plate (4) so that the surface area of the protrusion portions (3a) in contact with the air flow is increased to thereby enhance the cooing efficiency of the protrusion portions (3a).

### TECHNICAL FIELD

The present invention relates to a backlight structure used for a liquid crystal display apparatus, for example, and more particularly, to a backlight structure that has a forcible cooling function.

### BACKGROUND ART

Conventionally, as a backlight structure used for a liquid crystal display apparatus, there is a side-light type of backlight structure that includes: an LED module that has a plurality of LED (light emitting diode) chips; and a light guide plate that receives light from the LED module at an end surface and outputs the light from a front surface. In this conventional backlight structure, on an outside of a rear plate that houses the LED module and the light guide plate, a heat radiation fin is mounted. And, heat generated by light emission from the LED chip is conducted to the heat radiation fin via a fix member for fixing the LED module, a heat conductive sheet, and a heat conductive member; and natural cooling for discharging the heat into the air by means of the heat radiation fin is performed (e.g., see a patent document 1).

Conventionally, the light amount of the LED is relatively small, so that the backlight structure using the LED as the light source is used for small-sized electronic apparatuses such as a PDA (Personal Digital Assistant), a mobile phone and the like; in backlight structures for a large-sized electronic apparatuses such as a monitor apparatus and the like, a cold cathode lamp having a relatively large light amount is used. However, because of the development of high-brightness LEDs in recent years, LEDs are beginning to be used for light sources in backlight structures of large electronic apparatuses.

However, the high-brightness LED has a large heat generation amount, so that if the high-brightness LED is used for the light source in the conventional backlight structure, there is a problem that cooling of the light source becomes insufficient.

As measures that are generally known to improve the cooling capability of the conventional backlight structure, there are measures of increasing the size of a heat radiation fin, disposing a cooling fan and the like. Here, by means of only the size increase of the heat radiation fin, the increase in the cooling capability is limited, so that it is necessary to dispose a cooling fan in addition to the size increase of the heat radiation fin.

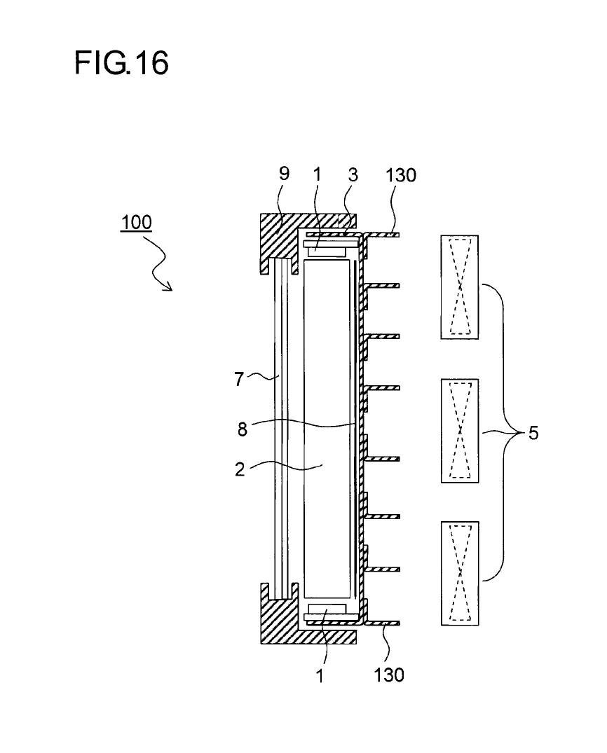

The conventional backlight structure including the heat radiation fin and the cooling fan is shown in FIG. 16. This backlight structure is of a side-light type, and includes: a pair of light source modules 1 that are disposed near both of upper and lower end edges of a liquid crystal display apparatus; a light guide plate 2 that is disposed between the light source modules 1; a metal rear plate 3 that is disposed to rear sides of the light source module 1 and the light guide plate 2; a plurality of heat radiation fins 130 that are mounted on a flat surface 3b of the rear plate 3; and a plurality of cooling fans 5 that are disposed to the rear side at predetermined intervals.

However, there is a disadvantage that these measures bring size and cost increases of the backlight structure. In detail, if the cooling fan is disposed in the conventional backlight structure, as shown in FIG. 16, the cooling fan 5 is disposed at a predetermined-distance away position from the rear side of the heat radiation fin 130, so that the thickness of the backlight structure increases to become large. Besides, if the heat radiation fin 130 is enlarged, the plurality of cooling fans 5 are needed to equally send a wind to the large heat radiation fin 130.

Here, if the number of cooling fans is deficient, unevenness cooling of the heat radiation fin is likely to occur; as a result of this, unevenness occurs in the heat radiation from the LED module; unevenness occurs in the light amount of the plurality of LED chips, which has a risk of bringing brightness unevenness and color unevenness in an image on the liquid crystal display panel, so that in the case where the large heat radiation fin is used, many cooling fans are needed. As described above, if many cooling fans are used, winds are likely to interfere with each other and the cooling efficiency is likely to deteriorate, so that a powerful cooling fan is needed, which brings a dramatic cost increase. Besides, if many cooling fans are used, complication of the backlight structure and noise increase are brought.

Besides, the conventional backlight structure conducts the heat from the LED chip to the heat radiation fin via a plurality of components such as a fix member, a heat conductive sheet, a heat conductive member and the like, so that there is a problem that the heat transfer efficiency from the LED chip to the heat radiation fin is low and it is hard to improve the cooling capability,

Accordingly, a backlight structure is proposed, which is able to efficiently cool a light source by means of a simple structure without bringing the size and cost increases; for example, a patent document 2 discloses a backlight structure in which a rear plate is disposed to rear sides of a light source module and a light guide plate, and a protrusion portion is disposed at a portion which is part of the rear plate and faces the light source module; a fan mount plate for fixing a cooling fan is disposed such that a gap is formed between the fan mount plate and the rear plate; and a first wind passage is formed to discharge a wind, which is supplied from the cooling fan and flown in the gap between the rear plate and the fan mount plate, along a surface of the protrusion portion of the rear plate.

### CITATION LIST

### Patent Literature

PLT1: JP-A-2006-156324

PLT2: International Publication No. 2008/090642

### SUMMARY OF INVENTION

### Technical Problem

According to the backlight structure in the patent document 2, the heat from the light source module is collected onto the protrusion portion of the rear plate, and the wind from the cooling fan is guided to the protrusion portion via the first wind passage, which is formed between the rear plate and the fan mount plate, to radiate the heat, so that it is possible to effectively improve the cooling efficiency. However, according to the structure in the patent document 2, the wind from the cooling fan impinges on a portion (a vertical surface that faces the first wind passage) only of the surface of the protrusion portion, and the wind impinging on the protrusion portion immediately diffuses toward the rear surface of the fan mount plate, so that there is a challenge of further improving the cooling efficiency.

Besides, a method is conceivable, in which the fan mount plate is extended toward the protrusion portion and so disposed as to cover the rear surface of the protrusion portion; however, according to this structure, the width of the first wind passage that is formed between the rear plate and the fan mount plate widens. Because of this, a disadvantage rises, in which the wind from the cooling fan comes not to efficiently flow in the first wind passage and the thickness of the backlight structure increases.

The present invention, in light of the above problems, has an object to provide a thin backlight structure that guides a large amount of air flow to a rear-plate surface near a light source module, thereby allowing the light source to be efficiently cooled.

### Solution to Problem

To solve the above problems, a backlight structure according to the present invention includes:
a light source module that has a plurality of light sources;
a light guide plate that outputs light, which is input via an end surface from the light source of the light source module, from a front surface to guide the light to a display panel;
a rear plate which is disposed to rear sides of the light guide plate and the light source module; and at a portion which is part of the rear plate and faces the rear side of the light source module, the rear plate is provided with a protrusion portion which protrudes backward;
a cooling fan that is so disposed as to face a portion which faces a rear side of the rear plate and is other than the protrusion portion;
a fan mount plate, on which the cooling fan is mounted, is so disposed as to collaborate with the rear plate to form a gap therebetween, and is provided with a bent portion along a shape of the protrusion portion; and
a first wind passage which is formed in the gap between the fan mount plate and the rear plate, and through which an air flow generated by the cooling fan passes touching at least part of a surface of the protrusion portion.

According to the above structure, heat generated from the light source of the light source module travels to the protrusion portion of the rear plate that is disposed to the rear side of the light source module, and the air flow passing through the first wind passage touches a surface of the protrusion portion to be radiated to outside. And, by forming the bent portion on the fan mount plate, which constitutes the first wind passage, along the shape of the protrusion portion, the area of the surface of the protrusion portion, with which the air flow touches, becomes large, so that it is possible to effectively improve the cooling efficiency.

Besides, even if a width of the first wind passage is narrowed, it is possible to surely make the air flow touch the surface of the protrusion portion, so that it is possible to narrow the gap between the rear plate and the fan mount plate; efficiently guide the air flow generated by the cooling fan to the protrusion portion; and secure the area of the surface of the protrusion portion with which the air flow touches. Accordingly, also in a case where a high-brightness LED is used as the light source, it is possible to efficiently cool the light source by means of a simple structure; as a result of this, a thin and low-cost side-light type of backlight structure, which is preferably used for a large electronic apparatus, is obtained.

Besides, in a backlight structure according to an embodiment of the present invention, the protrusion portion is formed by bending the rear plate; and part of the light source module is housed in an inside of the protrusion portion.

According to the above embodiment, the heat generated from the light source of the light source module is efficiently conducted to the protrusion portion of the rear plate, so that it is possible to efficiently cool the light source. Besides, even if a dimension of the light source module in a thickness direction of the backlight structure is large, part of the light source module is housed in the inside of the protrusion portion of the rear plate, so that it is possible to achieve thickness reduction of the backlight structure.

Besides, in a backlight structure according to an embodiment of the present invention, the light source module is composed of the plurality of light sources and a mount board on which the plurality of light sources are mounted; and the protrusion portion is part of the mount board which penetrates the rear plate to protrude into the first wind passage.

According to the above embodiment, it is possible to make the air flow in the first wind passage directly touch the mount board of the light source module, the cooling efficiency improves more.

Besides, in a backlight structure according to an embodiment of the present invention, the mount board is provided with a plurality of protrusion pieces that protrude toward the rear side at positions each of which corresponds to each of the light sources disposed on the mount board; and the protrusion pieces protrude into the first wind passage to form the protrusion portion.

According to the above embodiment, the heat generated from each light source is concentratedly accumulated into the corresponding protrusion piece and efficiently radiated by the air flow flowing in the first wind passage.

Besides, in a backlight structure according to an embodiment of the present invention, the bent portion is so formed as to enclose the protrusion portion.

According to the above embodiment, the air flow in the first wind passage becomes able to touch the entire surface of the protrusion portion, so that it is possible to more improve the cooling efficiency.

Besides, in a backlight structure according to an embodiment of the present invention, the cooling fan is an air suction fan; and the protrusion portion of the rear plate is situated near a discharge opening of the first wind passage.

According to the above embodiment, by making external cold air flow, which is guided to the first wind passage by the air suction fan, impinge on the protrusion portion and discharging the air flow from the discharge opening, it is possible to effectively improve the heat radiation efficiency from the protrusion portion.

Besides, in a backlight structure according to an embodiment of the present invention, between the rear pate and the fan mount plate, a partition plate for defining the first wind passage is disposed.

According to the above embodiment, by disposing the partition plate between the rear plate and the fan mount plate, it is possible to easily define a shape and a route of the first wind passage that efficiently guides the air flow to the protrusion portion.

Besides, in a backlight structure according to an embodiment of the present invention, on the fan mount plate, at least one of a drive circuit for the light source module and a drive circuit for the display panel is mounted.

According to the above embodiment, it is possible to use the fan mount plate as a mount space for at least one of the drive circuit for the light source module and the drive circuit for the display panel, so that it is possible to achieve size reduction of the backlight structure.

Besides, in a backlight structure according to an embodiment of the present invention, in the gap between the rear plate and the fan mount plate, a second wind passage, through which the air flow generated by the cooling fan passes touching a surface of the rear plate other than the protrusion portion, is disposed.

According to the above embodiment, in addition to the air flow that is guided by the first wind passage to cool the light source, by means of the second wind passage, it is possible to perform the cooling by guiding a stable-temperature air flow to a portion other than the protrusion portion of the rear plate and to a portion other than the bent portion of the fan mount plate.

Besides, in a backlight structure according to an embodiment of the present invention, between the rear plate and the fan mount plate, a partition plate for separating the first wind passage and the second wind passage from each other is disposed.

According to the above embodiment, it is possible to form the first wind passage and the second wind passage by means of a simple structure.

Besides, in a backlight structure according to an embodiment of the present invention, at a position of the fan mount plate where the second wind passage is disposed, at least one of the drive circuit for the light source module and the drive circuit for the display panel is mounted.

According to the above embodiment, by means of the air flow flowing in the second wind passage, it is possible to cool at least one of the drive circuit for the light source module and the drive circuit for the display panel without being influenced by the operation and heat generation of the light source.

Besides, in a backlight structure according to an embodiment of the present invention, the light source of the light source module is an LED.

According to the above embodiment, it is possible to efficiently radiate the heat, which is generated by the light emission from the LED, from the protrusion portion of the rear plate. Accordingly, by using a high-brightness LED that has a large heat generation amount, a backlight structure for a large electronic apparatus is obtained without bringing size increase and cost increase.

Besides, in a backlight structure according to an embodiment of the present invention, the cooling fan is an axial-flow fan or a sirocco fan.

According to the above embodiment, for example, when disposing the cooling fan to the rear side of the fan mount plate, the axial-flow fan is used; on the other hand, when disposing the cooling fan between the rear plate and the fan mount plate, the sirocco fan is used; as described above, by selecting a suitable type of cooling fan in accordance with the disposition position, it is possible to achieve the thickness reduction and cost reduction of the backlight structure.

### Advantageous Effects of Invention

According to the present invention, by efficiently guiding the air flow from the cooling fan to the surface of the protrusion portion that is so formed on the rear plate near the light source module as to protrude backward, it is possible to provide the thin backlight structure that is able to effectively cool the light source.

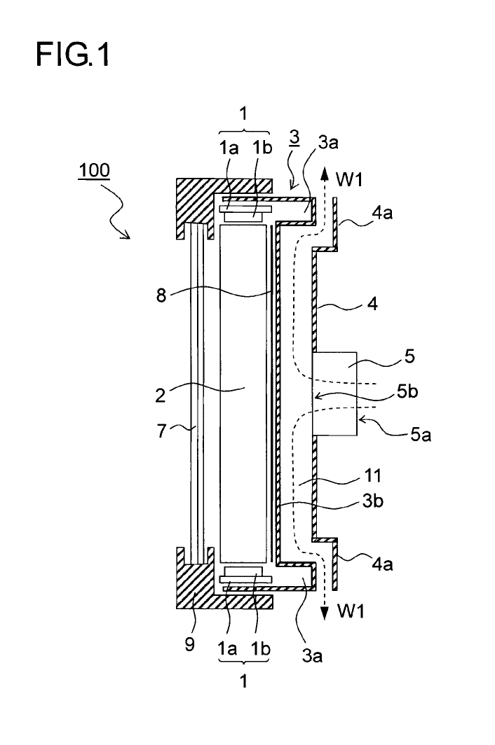

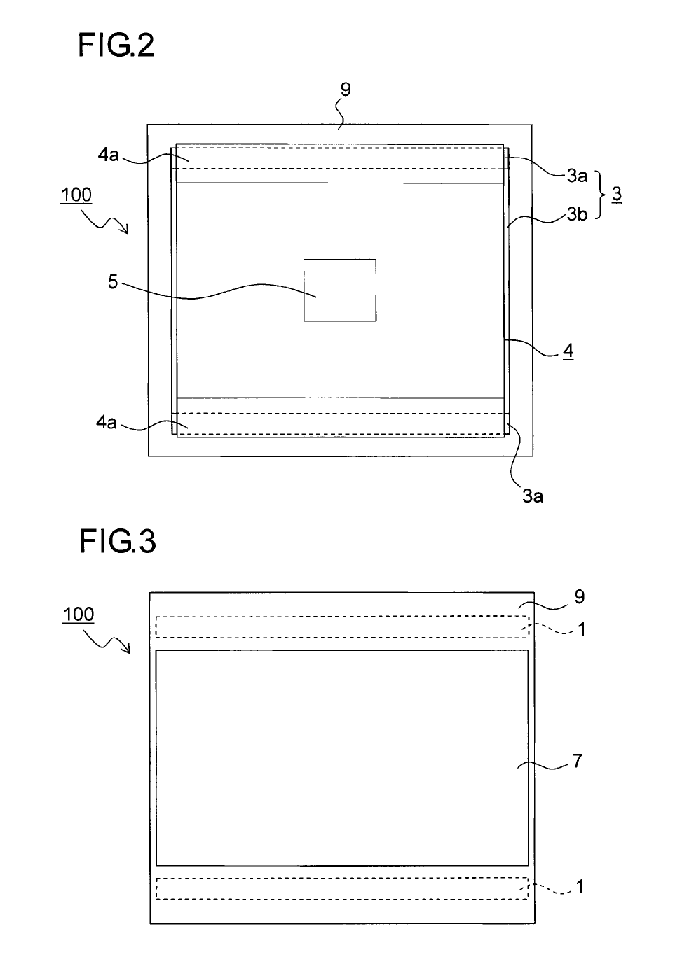

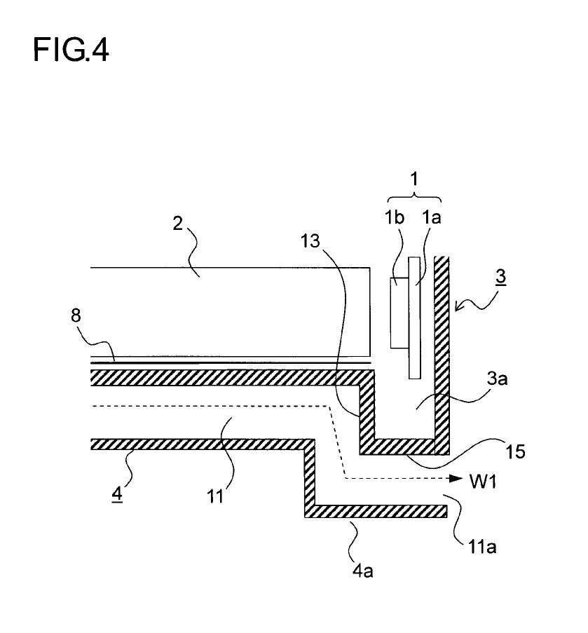

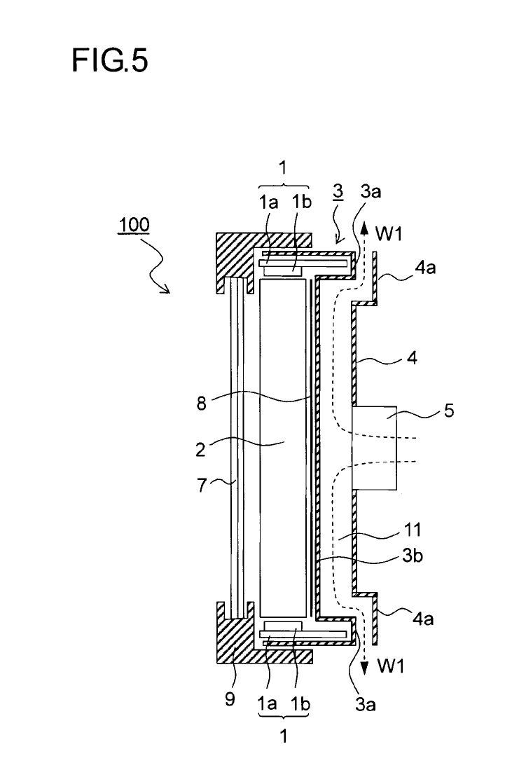

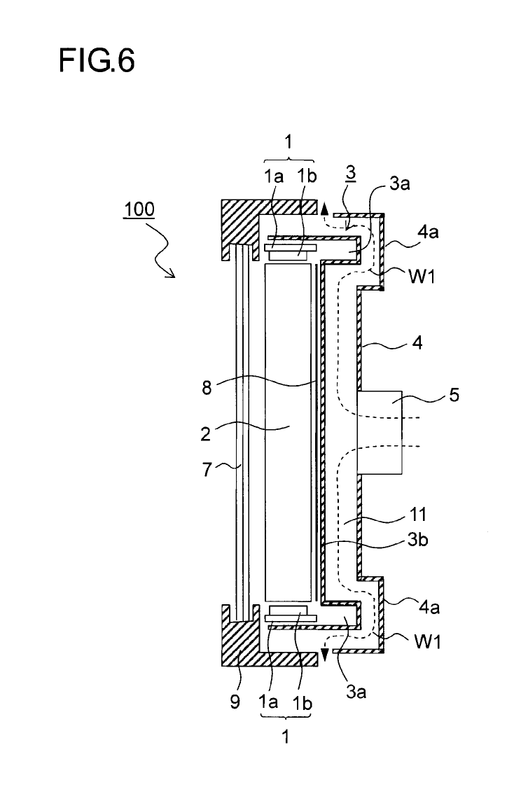

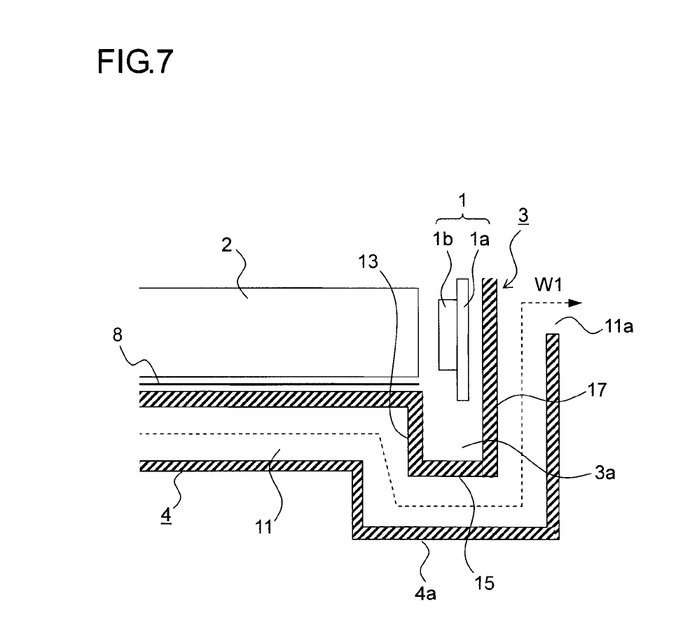

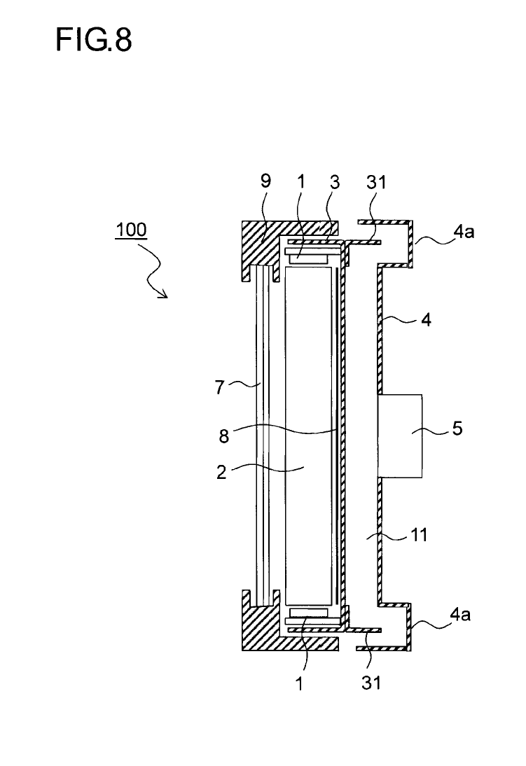

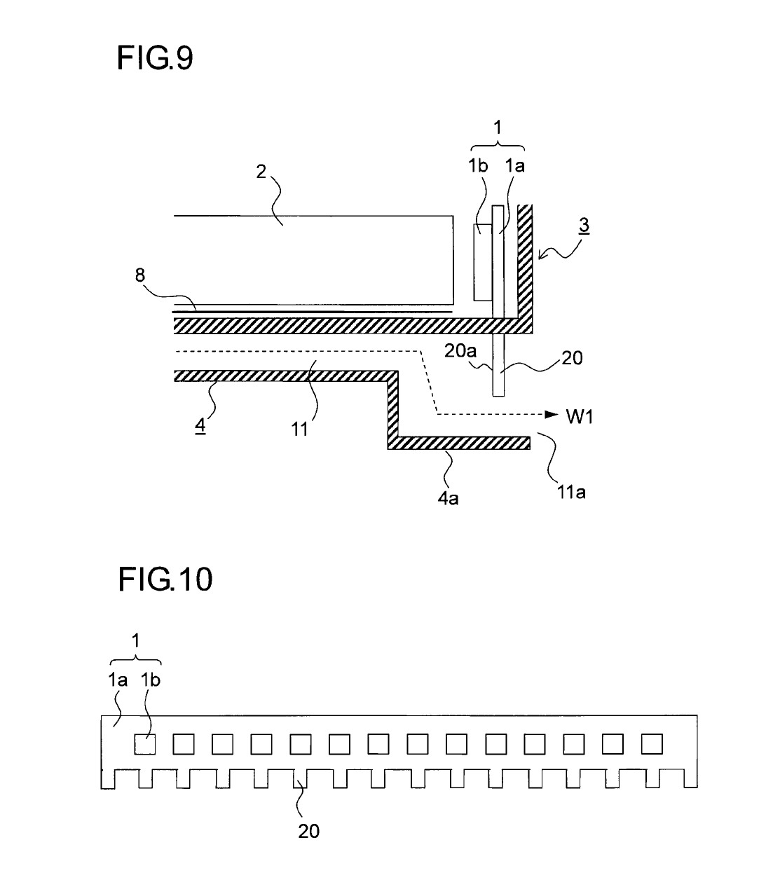

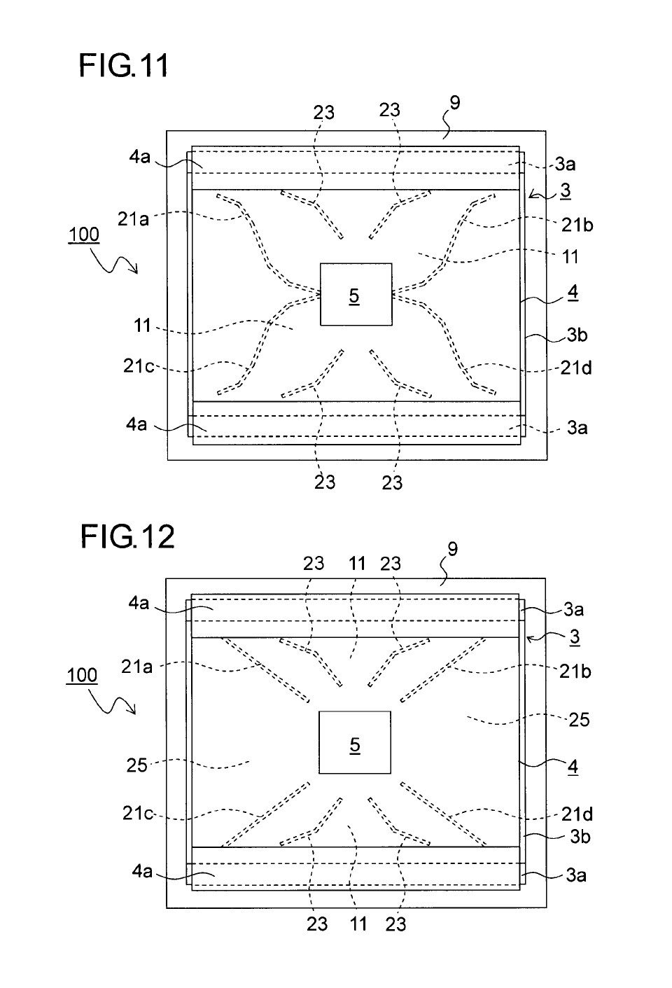

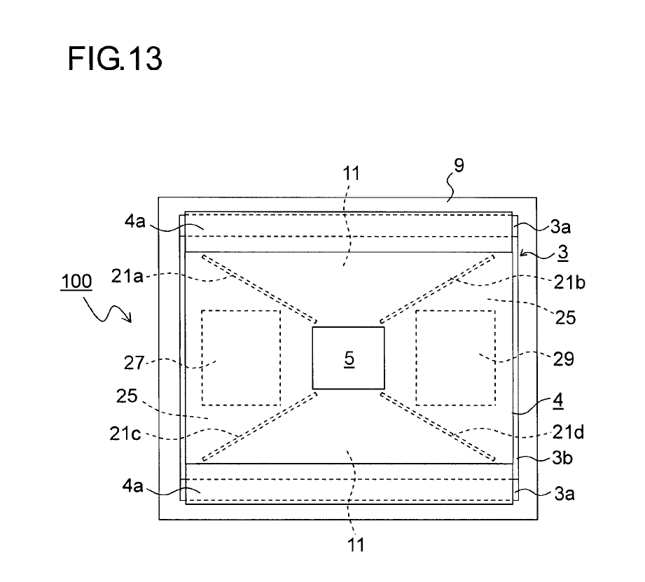

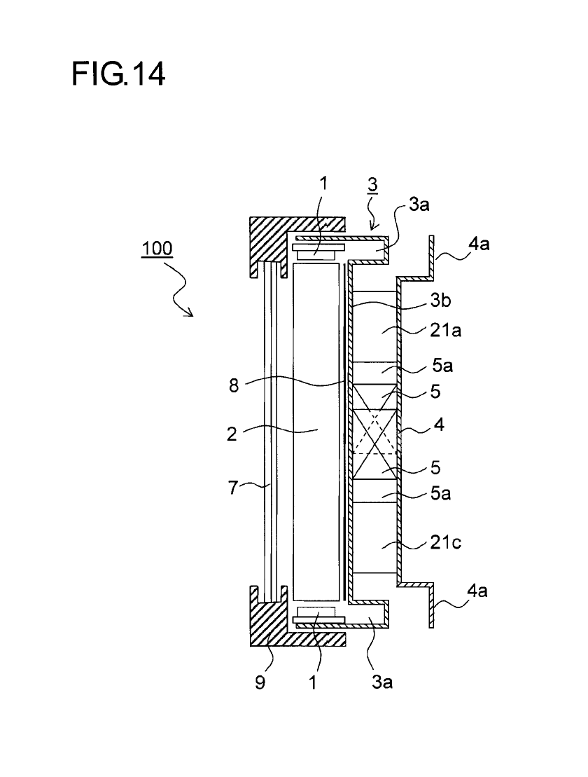

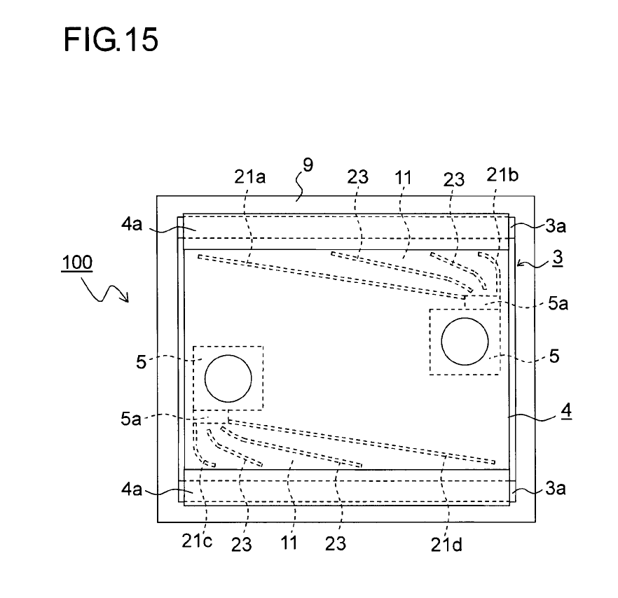

### BRIEF DESCRIPTION OF DRAWINGS

[FIG. 1] is a sectional view showing a liquid crystal display apparatus that has a backlight structure according to a first embodiment of the present invention.

[FIG. 2] is a rear view showing the liquid crystal display apparatus that has the backlight structure according to the first embodiment.

[FIG. 3] is a front view showing the liquid crystal display apparatus that has the backlight structure according to the first embodiment.

[FIG. 4] is a partial sectional view near a light source module in the liquid crystal display apparatus according to the first embodiment.

[FIG. 5] is a sectional view showing a backlight structure according to a modification of the first embodiment.

[FIG. 6] is a sectional view showing a liquid crystal display apparatus that has a backlight structure according to a second embodiment of the present invention.

[FIG. 7] is a partial sectional view near a light source module in the liquid crystal display apparatus in the second embodiment.

[FIG. 8] is a sectional view showing a liquid crystal display apparatus that has a backlight structure according to a third embodiment of the present invention.

[FIG. 9] is an enlarged view near a light source module in a backlight structure according to a fourth embodiment of the present invention.

[FIG. 10] is a plan view of the light source module used for the backlight structure according to the fourth embodiment

[FIG. 11] is a rear view of a liquid crystal display apparatus that has a backlight structure according to a fifth embodiment of the present invention.

[FIG. 12] is a rear view of a liquid crystal display apparatus that has a backlight structure according to a sixth embodiment of the present invention.

[FIG. 13] is a rear view of a liquid crystal display apparatus that has a backlight structure according to a seventh embodiment of the present invention.

[FIG. 14] is a sectional view showing a liquid crystal display apparatus that has a backlight structure according to an eighth embodiment of the present invention.

[FIG. 15] is a rear view showing a liquid crystal display apparatus that has the backlight structure according to the eighth embodiment.

[FIG. 16] is a sectional view showing a liquid crystal display apparatus that has a conventional side-light type of backlight structure.

### DESCRIPTION OF EMBODIMENTS

Hereinafter, embodiments of the present invention are described with reference to the drawings. FIG. 1 is a sectional view schematically showing a liquid crystal display apparatus that has a backlight structure according to a first embodiment of the present invention; FIG. 2 is a rear view of the liquid crystal display apparatus in FIG. 1; FIG. 3 is a front view of the liquid crystal display apparatus in FIG. 1; and FIG. 4 is an enlarged view near a light source module in the liquid crystal display apparatus in FIG. 1.

This backlight structure is of a side-light type, and includes: a pair of light source modules 1 that are disposed near both of upper and lower end edges of a liquid crystal display apparatus 100; a light guide plate 2 disposed between the light source modules 1; a metal rear plate 3 disposed to rear sides of the light source module 1 and the light guide plate 2; a fan mount plate 4 disposed to a rear side of and at a position a predetermined distance away from the rear plate 3; and a cooling fan 5 mounted on the fan mount plate 4.

The light source module 1 has: an elongate mount board 1a that extends in a width direction of the liquid crystal display apparatus 100; and LED chips 1b as a plurality of light sources that are linearly disposed on a surface of the mount board 1a that faces an end surface of the light guide plate 2.

The light guide plate 2 is so formed as to output light, which is input from the LED chip 1b of the light source module 1 via both of the upper and lower end surfaces, from a front surface. To a front side of the light guide plate 2, a liquid crystal display panel 7 is disposed. Besides, to a rear surface of the light guide plate 2, a reflection sheet 8 is disposed.

The rear plate 3 encloses both of upper and lower side surfaces of the light source module 1 and is so formed as to cover the rear surfaces of the light source module 1 and the light guide plate 2. The rear plate 3 has protrusion portions 3a that are portions of the upper and lower end edges of the rear plate 3 which are situated to the rear sides of the light source modules 1 and protrude backward. Besides, between the upper and lower protrusion portions 3a, a flat surface 3b is formed near the rear surface of the light guide plate 2. The protrusion portion 3a, corresponding to the disposition position of the light source module 1, is formed by bending the rear plate 3 into substantially a C shape along both of the upper and lower end edges.

The fan mount plate 4 has substantially the same dimensions in a width direction and a height direction as those of the rear plate 3; and is disposed in a back-forth direction at substantially the same position of the backward end of the protrusion portion 3a of the rear plate 3. Between the fan mount plate 4 and the rear plate 3, a cooling wind passage 11 as a first wind passage is formed; and at both of the upper and lower end edges of the fan mount plate 4, L-shape bent portions 4a are formed in accordance with the shape of the protrusion portion 3a. And, between the protrusion portions 3a on both of the upper and lower sides of the rear plate 3 and the bent portions 4a of the fan mount plate 4, discharge openings 11a of the cooling wind passage 11 are formed.

The cooling fan 5 is formed of an axial-flow fan; inhales air from an air inlet 5a disposed through the rear surface and exhales a wind into the cooling wind passage 11 from an air outlet 5b disposed through the front surface.

As described above, the backlight structure, in which each component is mounted on the rear plate 3, is connected to a plastic frame 9 for supporting the liquid crystal display panel 7 to constitute the liquid crystal display apparatus 100.

The liquid crystal display apparatus 100 having the above-configured backlight structure operates as follows. In other words, if a power-supply switch of the liquid crystal display apparatus 100 is turned on, a not-shown power-supply circuit starts to supply electricity to the light source module 1, whereby the plurality of LED chips 1b of the light source module 1 emit light. The emitted light from the LED chip 1b enters via both end surfaces of the light guide plate 2, is conducted in the light guide plate 2 and output from the front surface. The light output from the front surface of the light guide plate 2 enters the liquid crystal display panel 7; the light transmittance is controlled in accordance with a control signal and an image signal that are input into the liquid crystal display panel 7, so that a predetermined image is displayed on a screen.

At the same time, thanks to the startup of the liquid crystal display apparatus 100, the cooling fan 5 operates, so that an air flow indicated by an arrow W1 is generated through the cooling wind passage 11. Here, heat generated by the light emission from the LED chip 1b travels in the mount board 1a and concentrates on the protrusion portion 3a of the rear plate 3. The heat concentrating on the protrusion portion 3a is received by the air flow that passes through the cooling wind passage 11 and discharged from the discharge opening 11a.

The protrusion portion 3a is situated to the rear surface of the light source module 1, so that the protrusion portion 3a is able to efficiently collect the heat from the LED chip 1b. Besides, the protrusion portion 3a has a protrusion shape, so that the surface area becomes large and further the air flow guided by the cooling wind passage 11 touches the protrusion portion 3a, whereby it is possible to efficiently radiate the heat from the LED chip 1b and effectively cool the LED chip 1b. And, the protrusion portion 3a for performing the heat radiation is integrally formed of the same member of the flat portion 3b that forms the cooling wind passage 11, so that a high cooling efficiency is obtained and it is possible to reduce the number of components. As a result of this, the heat is conducted from the LED chip 1b to the protrusion portion 3a via a small number of components compared with the conventional structure, so that it is also possible to improve both of the heat transfer efficiency and the cooling efficiency.

Besides, the fan 5 is mounted on the fan mount plate 4 that is situated to the rear side of the flat surface 3b of the rear plate 3 and the cooling wind passage 11 is formed between the flat surface 3b of the rear plate 3 and the fan mount plate 4, so that despite the forcible cooling performed by means of the fan 5, a small-thickness backlight structure is obtained.

Besides, the protrusion portion 3a is cooled by the air flow that flows in the cooling wind passage 11, so that it is possible to reduce unevenness of the cooling compared with a structure in which a heat radiation fin is mounted and a wind is sent from a cooling fan to the heat radiation fin. Accordingly, to prevent the cooling unevenness, it is not necessary to increase the number of cooling fans and use a large-capacity fan, so that it is possible to achieve an increase in the cooling performance without increasing the number of components and the cost.

Here, the heat generated by the light emission from the LED chip 1b concentrates on an inside surface 13 and a tip-end surface 15 of the protrusion portion 3a near the LED chip 1b shown in FIG. 4, so that the temperatures of the inside surface 13 and the tip-end surface 15 rise. Accordingly, in the present embodiment, the bent portion 4a is disposed in accordance with the shape of the protrusion portion 3a.

According to this structure, the air flow W1 flowing in the cooling wind passage 11 touches the inside surface 13 and the tip-end surface 15, thereafter, is discharged from the discharge opening 11a. As a result of this, of the surface of the protrusion portion 3a, the area, with which the air flow touches, becomes large, so that it is possible to more increase the cooling efficiency of the protrusion portion 3a. Besides, even if the width of the cooling wind passage 11 is narrowed, it is possible to surely make the air flow W1 touch the inside surface 13 and the tip-end surface 15; accordingly, even in a case where the gap between the rear plate 3 and the fan mount plate 4 is narrowed to obtain a thin backlight structure, it is possible to maintain the cooling efficiency of the protrusion portion 3a.

As described above, in the backlight structure according to the present embodiment, by means of a simple structure that has a small number of components, it is possible to achieve thickness reduction and obtain a good cooling performance, so that it is possible to use a high-brightness LED, which has a large heat generation amount, as the light source. Accordingly, it is possible to achieve a backlight structure that is incorporable in large electronic apparatuses such as a large-screen television and the like which use the high-brightness LED as the light source.

In the backlight structure according to the first embodiment, the protrusion portion 3a of the rear plate 3 may perform the heat radiation and house other components. FIG. 5 is a sectional view showing a backlight structure according to a modification of the first embodiment. In FIG. 5, the dimension in the width direction (back-forth direction of the backlight structure) of the mount board la of the light source module 1 is larger than that in FIG. 1; and the rear-surface portion of the mount board 1a is disposed in the inside of the protrusion portion 3a. As described above, even if the light source module 1 having the large dimension in the width direction is used, it is possible to obtain a thin backlight structure without enlarging the dimension in the back-forth direction of the rear plate 3. Besides, by housing part of the light source module 1 in the inside of the protrusion portion 3a that receives the air flow generated by the cooling fan 5, it is possible to further improve the cooling efficiency for the LED chip 1b that is the light source.

FIG. 6 is a sectional view schematically showing a liquid crystal display apparatus that has a backlight structure according to a second embodiment of the present invention; FIG. 7 is an enlarged view near a protrusion portion in the liquid crystal display apparatus in FIG. 6. In the backlight structure according to the present embodiment, at both of the upper and lower end edges of the fan mount plate 4, the bent portions 4a each having substantially a C shape in section are so formed as to enclose the protrusion portions 3a. Because the structures of the other portions are the same as the first embodiment, description of them is skipped.

According to this structure, the air flow flowing in the cooling wind passage 11 touches not only the inside surface 13 and the tip-end surface 15 of the protrusion portion 3a but also an outside surface 17, thereafter, is discharged from the discharge opening 11a. As a result of this, of the surface of the protrusion portion 3a, the area, with which the air flow touches, becomes larger than that of the first embodiment, so that it is possible to more increase the cooling efficiency of the protrusion portion 3a.

FIG. 8 is a sectional view schematically showing a liquid crystal display apparatus that has a backlight structure according to a third embodiment of the present invention. The backlight structure according to the present embodiment has the same structure as the second embodiment except that the protrusion portion 3a is not integrally formed with the rear plate 3; and a protrusion member 31 having substantially an L shape in section is disposed. In the present embodiment, the heat from the LED chip 1b is conducted to the additional protrusion members 31 disposed at both of the upper and lower end edges of the rear surface of the rear plate 3; and the air flow generated by the cooling fan 5 is made to touch the protrusion member 31 to perform the heat radiation.

In the backlight structure as well according to the present embodiment, like in the second embodiment, at both of the upper and lower end edges of the fan mount plate 4, the bent portions 4a each having substantially a C shape in section are so formed as to enclose the protrusion portions 3a. According to this, the air flow flowing in the cooling wind passage 11 becomes able to touch both of the inside surface and outside surface of the protrusion member 31, so that is possible to increase the cooling efficiency of the protrusion member 31.

Here, in the backlight structure according to the third embodiment, the protrusion member 31 is a member different from the rear plate 3, so that the heat transfer efficiency is lower than the second embodiment; and the protrusion member 31 has a plate-like shape, so that the heat radiation area is smaller and the heat radiation efficiency is lower than the second embodiment. Accordingly, the cooling efficiency for the light source becomes lower than the second embodiment. On the other hand, in the backlight structure according to the second embodiment, by means of the protrusion portion 3a that is integrally formed with part of the rear plate 3, so that it is possible to efficiently conduct the heat from the light source module 1 to the protrusion portion 3a; besides, it is possible to efficiently radiate the heat by means of the large heat radiation area; and it is possible to reduce the number of components, which is more preferred.

FIG. 9 is an enlarged view near a light source module in a backlight structure according to a fourth embodiment of the present invention; FIG. 10 is a plan view (view seen from a left direction in FIG. 9) of the light source module used for the backlight structure according to the fourth embodiment. In the backlight structure according to the present embodiment, like in the third embodiment, the protrusion portion 3a is not integrally formed with the rear plate 3; at portions corresponding to the respective LED chips 1b that are disposed on the mount board 1a of the light source module 1, a plurality of protrusion pieces 20, which protrude to the rear surface (downward in FIG. 9), are formed; the protrude piece 20 penetrates the rear plate 3 to protrude into the cooling wind passage 11. In other words, instead of the protrusion member 31, the protrusion piece 20 is made to touch the air flow W1 generated by the cooling fan 5 to perform the heat radiation. Because the structures of the other portions are the same as the first embodiment, description of them is skipped.

According to this structure, the protrusion piece 20, which is part of the mount board 1a, protrudes in the cooling wind passage 11, so that the air flow directly touches the mount board 1a. Accordingly, it is possible to more efficiently radiate the heat generation from the light source module 1 compared with the first to third embodiments.

Besides, like in the first embodiment, both of the upper and lower end edges of the fan mount plate 4 are bent into L shapes in accordance with the protrusion piece 20 to form the bent portions 4a, the air flow flowing in the cooling wind passage 11 becomes able to touch the entire inside surface 20a of the protrusion piece 20. Accordingly, of the surface of the protrusion piece 20, the area, with which the air flow touches, becomes large, so that it is possible to more increase the cooling efficiency. Further, even if the width of the cooling wind passage 11 is narrowed, it is possible to surely make the air flow touch the entire protrusion piece 20, so that it also becomes possible to achieve thickness reduction of the backlight structure.

Besides, as shown in FIG. 10, each protrusion piece 20 is formed at a position corresponding to each LED chip 1b in a longitudinal direction of the mount board 1a, so that the heat generated from the LED chip 1b is concentratedly accumulated into the corresponding protrusion piece 20 and efficiently radiated by the air flow flowing in the cooling wind passage 11.

Here, like in the second and third embodiments, if the bent portion 4a, which encloses the protrusion piece 20 and has substantially the C shape in section, is formed, it is possible to make the air flow touch both of the inside surface and outside surface of the protrusion piece 20, so that the cooling efficiency further improves. Besides, like in the first and second embodiments, a structure may be employed, in which the protrusion portion 3a is integrally formed with the rear plate 3; and the protrusion piece 20 protrudes in the cooling wind passage 11 from the tip-end surface 15 (see FIG. 4) of the protrusion portion 3a. According to this structure, it is possible to expect a synergistic effect of: an effect of cooling the protrusion portion 3a on which the heat from the LED chip 1b concentrates; and an effect of directly cooling the mount board 1a via the protrusion piece 20.

FIG. 11 is a rear view of a liquid crystal display apparatus that has a backlight structure according to a fifth embodiment of the present invention. The backlight structure according to the present embodiment has the same structure as the first embodiment except that partition plates 21a to 21d and an air-flow adjustment plate 23 are disposed between the rear plate 3 and the fan mount plate 4. Portions common to FIG. 2 for the first embodiment are indicated by the same reference numbers and description of them is skipped.

In the backlight structure according to the present embodiment, between the flat surface 3b of the rear plate 3 and the inside surface of the fan mount plate 4 that faces the flat surface 3b, the four partition plates 21a to 21d for defining the cooling wind passage 11 are fixed. As shown in FIG. 11, two partition plates 21a, 21b and 21c, 21d bend and extend from both sides of the cooling fan 5 toward both ends of the protrusion portion 3a of the rear plate 3, whereby between the partition plates 21a, 21b and between the partition plates 21c, 21d, two cooling wind passages 11 are defined on an upper side and a lower side of the cooling fan 5.

In the two cooling wind passages 11 defined by the partition plates 21a, 21b and the partition plates 21c, 21d, two air-flow adjustment plates 23 are disposed, respectively. The air-flow adjustment plates 23, like the partition plates 21a to 21d, are fixed between the flat surface 3b of the rear plate 3 and the inside surface of the fan mount plate 4. The two air-flow adjustment plates 23 are substantially symmetrically disposed left an right in each cooling wind passage 11; and are so formed as to be away from each other from the cooling fan 5 toward the protrusion portion 3a of the rear plate.

According to this structure, it is possible to: guide the air flow generated by the cooling fan 5 to the protrusion portions 3a of the rear plate 3 by means of the two cooling wind passages 11 that are partitioned by the two partition plates 21a, 21b and 21c, 21d; and reduce a loss in the flow by adjusting the air flow by means of the air-flow adjusting plates 23. Accordingly, it is possible to efficiently guide the air flow generated by the cooling fan 5 to the protrusion portion 3a to perform the heat radiation, and possible to improve the cooling efficiency of the light source.

FIG. 12 is a rear view of a liquid crystal display apparatus that has a backlight structure according to a sixth embodiment of the present invention. The backlight structure according to the present embodiment has the same structure as the fifth embodiment except that the shapes of the partition plates 21a to 21d are different. Portions common to FIG. 11 for the fifth embodiment are indicated by the same reference numbers and description of them is skipped.

In the backlight structure according to the sixth embodiment, as shown in FIG. 12, the four partition plates 21a to 21d for defining the cooling wind passage 11 are formed radially from positions away from the cooling fan 5 toward the four corners of the fan mount plate 4. And, in regions formed between the upper and lower partition plates 21a, 21c and 21b, 21d that are situated on the left and right sides of the cooling fan 5, bypass wind passages 25 as second wind passages are formed, respectively.

According to this structure, the air flow generated by the cooling fan 5 is guided by the cooling wind passage 11 to the protrusion portions 3a on the upper and lower sides of the rear plate 3; and also guided by the bypass wind passages 25 to both of the left and right side edge portions of the rear plate 3. Accordingly, by means of the cooling fan 5, it is possible to: perform the cooling of the protrusion portion 3a of the rear plate 3; and perform the cooling of the flat surface 3b of the rear plate 3 and the left and right portions of the fan mount plate 4.

FIG. 13 is a rear view of a liquid crystal display apparatus that has a backlight structure according to a seventh embodiment of the present invention. The backlight structure according to the present embodiment has the same structure as the sixth embodiment except that the air-flow adjustment plate 23 is not disposed in the cooling wind passage 11; and a liquid crystal panel drive circuit 27 and an LED drive power-supply circuit 29 are mounted in the bypass wind passage 25. Portions common to FIG. 12 for the sixth embodiment are indicated by the same reference numbers and description of them is skipped.

In the backlight structure according to the present embodiment, as shown in FIG. 13, at portions in the two bypass wind passages 25, the liquid crystal panel drive circuit 27 and the LED drive power-supply circuit 29 are disposed, respectively. According to this structure, it is possible to: perform the cooling of the LED by guiding the air flow generated by the cooling fan 5 to the cooling wind passage 11; and perform the cooling of the liquid crystal panel drive circuit 27 and the LED drive power-supply circuit 29 by guiding the air flow to the bypass wind passage 25. Here, in the present embodiment, the air flow is made to directly impinge on the liquid crystal panel drive circuit 27 and the LED drive power-supply circuit 29 disposed in the bypass wind passages 25 to perform the cooling; however, the cooling may be performed via the fan mount plate 4 by disposing at least one of the liquid crystal panel drive circuit 27 and the LED drive power-supply circuit 29 at a position that is on the rear surface of the fan mount plate 4 and faces the rear surface of the bypass wind passage 25.

FIG. 14 is a sectional view schematically showing a liquid crystal display apparatus that has a backlight structure according to an eighth embodiment of the present invention; FIG. 15 is a rear view of the liquid crystal display apparatus in FIG. 14. Portions common to FIG. 1 and FIG. 2 for the first embodiment are indicated by the same reference numbers and description of them is skipped. In the backlight structure according to the present embodiment, two cooling fans 5 that are each a sirocco fan are mounted on a surface of the fan mount plate 4 that faces the rear plate 3; and the winds from the two cooling fans 5 are independently guided to the protrusion portions 3a of the rear plate 3 by means of the two cooling wind passages 11.

As shown in FIG. 15, the two cooling fans 5 are mounted at portions that are near both of the left and right side edges of the fan mount plate 4 and at substantially centers in a vertical direction of the fan mount plate 4. The two partition plates 21a, 21b and 21c, 21d are disposed from both of the left and right ends of the air outlets 5a of the respective cooling fans 5 toward both of the left and right ends of the protrusion portions 3a of the rear plate 3. Between the partition plates 21a, 21b and between the partition plates 21c, 21d, two cooling wind passages 11 are formed; and two air-flow adjustment plates 23 are disposed in each cooling wind passage 11.

In the backlight structure according to the present embodiment, the cooling fan 5 is housed in the gap between the rear plate 3 and the fan mount plate 4, so that it is possible to provide a good appearance by making the rear surface of the rear plate 3 flat; and further reduce the total thickness. Besides, by using the sirocco fan as the cooling fan 5, it is possible to achieve the size reduction of the cooling fan 5 while securing a wind amount. Accordingly, it is possible to achieve further thickness reduction of the backlight structure without sacrificing the cooling performance for the light source.

Here, in each of the above embodiments, as the cooling fan 5, an air suction fan for guiding external air into the inside of the apparatus is used; however, in the backlight structure according to the present invention, the area of the protrusion portion 3a, the protrusion member 31, or the protrusion piece 20, with which the air flow in the cooling wind passage 11 touches, increases, so that it is also possible to use an air discharge fan as the cooling fan 5 for discharging the air in the inside of the apparatus to outside. However, making cold external air touch the protrusion portion 3a and the like is able to more improve the cooling efficiency, so that it is more preferred to use the air suction fan.

Besides, the present invention is not limited to each of the above embodiments, and various modifications are possible without departing from the spirit of the present invention. In other words, it is of course possible to use a suitable combination of the embodiments in accordance with applications and purposes.

Besides, in each of the above embodiments, the backlight structure according to the present invention is used for the liquid crystal display panel to compose the liquid crystal display apparatus; however, the backlight structure according to the present invention may be used for illumination of other image display apparatuses. Besides, the light source used for the light source module is not limited to the LED, and other light emitting devices may be used.

### INDUSTRIAL APPLICABILITY

The present invention is applicable to a backlight unit used for illumination of a liquid crystal display apparatus and the like; and provides a backlight structure that guides a large amount of air flow to a surface of a protrusion portion of a rear plate disposed near a light source module, thereby allowing heat from the light source to be efficiently radiated via the protrusion portion; and allows thickness reduction of the backlight unit.

Besides, by using the backlight structure according to the present invention, it is possible to: provide liquid crystal display apparatuses such as a flat liquid crystal television, a liquid crystal monitor and the like that are excellent in producibility and durability; and also contribute to thickness reduction and weight reduction of the liquid crystal display apparatus.

### REFERENCE SIGNS LIST

1 light source module

1a mount board

1b LED chip

2 light guide plate

3 rear plate

3a protrusion portion

3b flat surface

4 fan mount plate

4a bent portion

5 cooling fan

11 cooling wind passage (first wind passage)

13 inside surface (of protrusion portion)

15 tip-end surface (of protrusion portion)

17 outside surface (of protrusion portion)

20 protrusion piece

21a to 21d partition plate

23 air-flow adjustment plate

25 bypass wind passage (second wind passage)

27 liquid crystal panel drive circuit

29 LED drive power-supply circuit

31 protrusion member

100 liquid crystal display apparatus

1. A backlight structure comprising:
a light source module that has a plurality of light sources;
a light guide plate that outputs light, which is input via an end surface from the light source of the light source module, from a front surface to guide the light to a display panel;
a rear plate which is disposed to rear sides of the light guide plate and the light source module; and at a portion which is part of the rear plate and faces the rear side of the light source module, the rear plate is provided with a protrusion portion which protrudes backward;
a cooling fan that is so disposed as to face a portion which faces a rear side of the rear plate and is other than the protrusion portion;
a fan mount plate, on which the cooling fan is mounted, is so disposed as to collaborate with the rear plate to form a gap therebetween, and is provided with a bent portion along a shape of the protrusion portion; and
a first wind passage which is formed between the fan mount plate and the rear plate, and through which an air flow generated by the cooling fan passes touching at least part of a surface of the protrusion portion.

2. The backlight structure according to claim 1, wherein the protrusion portion is formed by bending the rear plate; and part of the light source module is housed in an inside of the protrusion portion.

3. The backlight structure according to claim 1, wherein the light source module is composed of the plurality of light sources and a mount board on which the plurality of light sources are mounted; and the protrusion portion is part of the mount board which penetrates the rear plate to protrude into the first wind passage.

4. The backlight structure according to claim 3, wherein the mount board is provided with a plurality of protrusion pieces that protrude toward the rear side at positions each of which corresponds to each of the light sources disposed on the mount board; and the protrusion pieces protrude into the first wind passage to form the protrusion portion.

5. The backlight structure according to claim 1, wherein the bent portion is so formed as to enclose the protrusion portion.

6. The backlight structure according to claim 1, wherein the cooling fan is an air suction fan; and the protrusion portion is situated near a discharge opening of the first wind passage.

7. The backlight structure according to claim 1, wherein between the rear pate and the fan mount plate, a partition plate for defining the first wind passage is disposed.

8. The backlight structure according to claim 1, wherein on the fan mount plate, at least one of a drive circuit for the light source module and a drive circuit for the display panel is mounted.

9. The backlight structure according to claim 1, wherein between the rear plate and the fan mount plate, a second wind passage, through which the air flow generated by the cooling fan passes touching a surface of the rear plate other than the protrusion portion, is disposed.

10. The backlight structure according to claim 9, wherein between the rear plate and the fan mount plate, a partition plate for separating the first wind passage and the second wind passage from each other is disposed.

11. The backlight structure according to claim 9, wherein at a position of the fan mount plate where the second wind passage is disposed, at least one of the drive circuit for the light source module and the drive circuit for the display panel is mounted.

12. The backlight structure according to claim 1, wherein the light source of the light source module is an LED.

13. The backlight structure according to claim 1, wherein the cooling fan is an axial-flow fan or a sirocco fan.
